(19) United States
(12) Patent Application Publication
(10) Pub. No.: US 2007/0109963 A1
(43) Pub. Date: May 17, 2007

(54) Internet protocol telephony proxy device

(76) Inventors: Edward Walter, Boerne, TX (US); Robert Lowmaster, Bartlett, IL (US)

Correspondence Address: BRINKS HOFER GILSON & LIONE, P.O. BOX 10395, CHICAGO, IL, 60610, US

(21) Appl. No.: 11/281,248

(22) Filed: Nov. 17, 2005

(51) Int. Cl. H04L 12/26; H04L 9/32

(52) U.S. Cl. 370/230; 726/4

(57) ABSTRACT

An Internet protocol telephony proxy device having a processor configured to execute a first, second and third logic is described therein. When the first logic is executed by the processor, the processor will be configured to authenticate a remote VoIP client. Next, when the processor executes the second logic, the processor will be configured to provide a secure connection to the remote VoIP client. Finally, when the processor executes the third logic, the processor will be configured to route incoming and outgoing calls to and from the remote VoIP client.

### TECHNICAL FIELD

The present disclosure generally relates to voice over Internet protocol (“VoIP”) telephone networks and more specifically to VoIP telephone networks.

### BACKGROUND

As shown in U.S. Publication 2003/0095644 A1 to St-Onge et al., a system would provide telephone services to a remote client by having the remote client access and tunnel through a local area network (“LAN”). Afterwards, the telephone call made by the remote client will be routed through the LAN where eventually the telephone call will be directed to a telephone service provider. In like manner, when the remote client receives an incoming call from the service provider network, the call must traverse the LAN.

Although this system provides telephone services to the remote client, a very large communication path is created. This may be preferable when the user wishes to use not only telephone services, but also access any network services the LAN may offer, such as email and remote file access. However, when the remote client only wishes to use telephone services, this long communication path is unnecessary. Therefore, there exists a need for a system for providing telephone service for a remote client.

### BRIEF DESCRIPTION OF THE DRAWINGS

FIG. 1 is a block diagram of a VoIP telephone network according to one embodiment;

FIG. 2 is a block diagram of an IPT proxy device for use in the network of FIG. 1;

FIG. 3 is a block diagram of the method for routing incoming and outgoing telephone calls; and

FIG. 4 is a block diagram of a general computer system.

### DETAILED DESCRIPTION

An embodiment of the system provides an Internet Protocol Telephony (“IPT”) proxy device having a processor configured to execute a first, second and third logic. When the first logic is executed by the processor, the processor will be configured to authenticate a remote VoIP client. The remote VoIP client may be software operating on a general purpose computer, but may be a dedicated device. Next, when the processor executes the second logic, the processor will be configured to provide a secure connection to the remote VoIP client. Alternatively, the connection is a clientless secure sockets layer connection. Finally, when the processor executes the third logic, the processor will be configured to route incoming and outgoing calls to and from the remote VoIP client.

In another embodiment of the invention, a system for redirecting VoIP telephone calls includes an IPT proxy device in communication with the Internet and a remote VoIP client in communication with the Internet and configured to communicate to the IPT proxy device. Further, the IPT proxy device is configured to authenticate the remote VoIP client, provide a secure connection to the remote VoIP client and provide connectivity for the remote VoIP client to a VoIP service provider.

The above embodiment may further include a LAN in communication with the IPT proxy device. The LAN may further include a local VoIP client. The IPT proxy device is configured to authenticate the local VoIP client and provide connectivity for the local VoIP client to the VoIP service provider.

These and other aspects and advantages will become apparent upon reading the following in combination with the accompanying drawings.

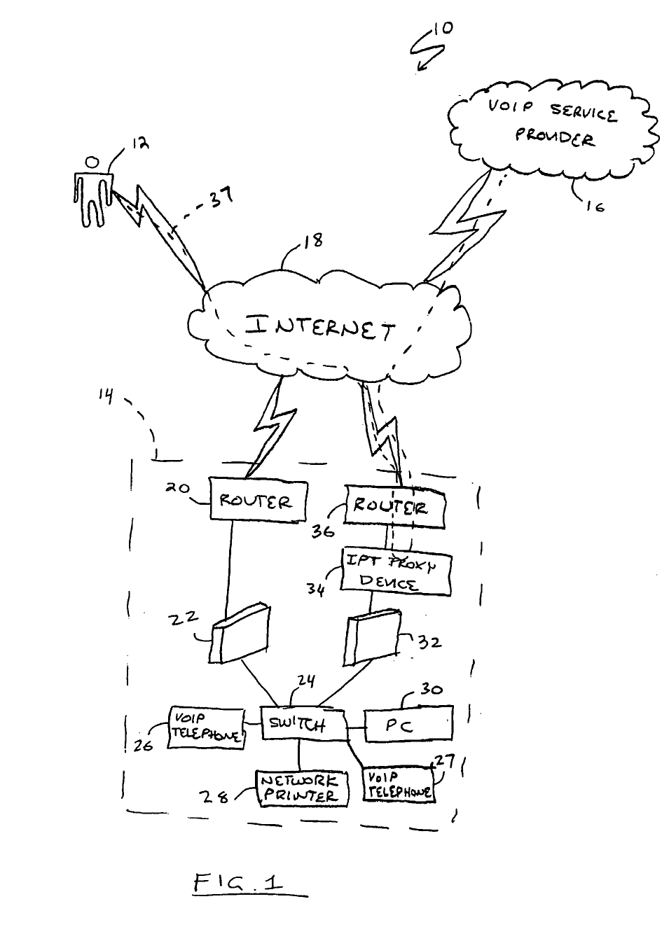

Referring to FIG. 1, a VoIP telephone network 10 with improved routing capabilities is shown. The VoIP telephone network 10 includes a remote VoIP client 12, a LAN 14 and a VoIP service provider network 16. The remote VoIP client 52 may be software operating on a general purpose computer, but also may be a dedicated device. Connecting the remote VoIP client 12, the LAN 14 and the VoIP service provider 16 is the Internet 18 or other communication path capable of transferring Internet Protocol (“IP”) packets. The communication path may be wired or wireless or any combination thereof.

Typically, the LAN 14 includes a data router 20 in communication with the Internet 18 and a firewall 22. In communication with the other side of the firewall 22 may be a switch 24 which is in communication with a variety of network devices such as a first and second VoIP telephone 26 and 27, a network printer 28 and a personal computer 30. The personal computer 30 will access the Internet 18 through the firewall 22 and the data router 20. Of course, the LAN 14 may have a variety of different configurations.

Also in communication with the switch 24 is a second firewall 32. In communication with the other side of the firewall 32 is an IPT proxy device 34 and a voice router 36. The VoIP telephones 26 and 27 may access the VoIP service provider network 16 via the Internet 18. In order to access the Internet 18, the VoIP telephones 16 and 17 interact with the IPT proxy device 34. When one of the VoIP telephones 26 and 27 places a telephone call, the IPT proxy device 34 will communicate this call to the VoIP service provider network 16 via the voice router 36. The VoIP service provider network 16 will then route the telephone call to the appropriate destination outside the LAN 14. Similarly, when one of the VoIP telephones 26 and 27 receives an incoming telephone call from the VoIP service provider network 16, the IPT proxy device 74 will direct the telephone call to the appropriate VoIP telephone 26 or 27 within the LAN 14.

When the remote VoIP client 12 wishes to use the VoIP telephone services provided by the LAN 14, the remote VoIP client 12 will first access the LAN 14 via the voice router 36. The VoIP client 12 will have a “Default Route” IP Address. The “Default Route” IP Address is the address of the voice router 36. In packet switched networks, such as the Internet, the data is split up into packets, each labeled with the complete destination address and routed individually. This has the benefit of routing incoming telephone calls to the remote VoIP client 12 and outgoing telephone calls from the remote VoIP client 12 without maintaining a virtual private network (“VPN”) tunnel traversing the LAN 14.

The VoIP Client 12 will attempt to make a VoIP telephone call across the Internet 18. The routing of IP Packets is performed via standard routing protocols such as Open Shortest Path First (“OSPF”) and Border Gateway Protocol (“BGP”). The location of the VoIP Client 12 is determined by a route table in the voice router 36. When the VoIP client 12 is registered with the IPT Proxy Device 34, the IP Address of the VoIP client 12 is provided. Afterwards, the telephone call made by the remote VoIP client 12 is routed to the IPT proxy device 34. The IPT proxy device 34 is configured to authenticate the remote VoIP client 12 and provide a secure connection to the remote VoIP client 12. Preferably, the secure connection is a clientless secure sockets layer (“SSL”) VPN connection. Thereafter, the IPT proxy device 34 will provide connectivity to the remote VoIP service provider network 16. In order to better illustrate the path a telephone call to or from the remote VoIP client 12 may take in one embodiment, a dashed line indicated by the reference numeral 37 is shown.

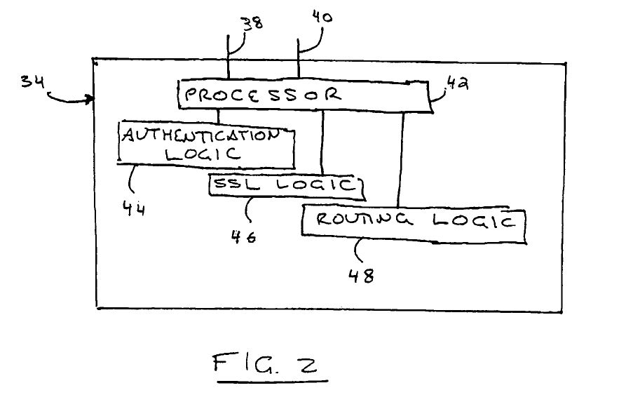

Referring to FIGS. 1 and 2, a block diagram of the IPT proxy device 34 is shown. The IPT proxy device 34 includes first and second interfaces 38 and 40. The first interface connects to the voice router 36 while the second interface 40 connects to the second firewall 32.

Within the IPT proxy device 34 is a processor 42 in communication with the interfaces 38 and 40. The processor 42 functions to authenticate the remote VoIP client 12, provide a secure connection with the remote VoIP client 12 and correctly route telephone calls to and from the VoIP service provider network 16 to either the remote VoIP client 12 or the VoIP telephones 26 and 27.

In order to accomplish this, the processor 42 is in communication with an authentication logic 44, a SSL logic 46 and a routing logic 48. When the authentication logic 44 is executed by the processor 42, the IPT proxy device 34 will authenticate the remote VoIP client 12. Either before or after authentication of the remote VoIP client 12, the processor 42 will execute the SSL logic 46 in order to provide a secure connection to the remote VoIP client 12. In one embodiment, the secure connection is a clientless secure sockets layer connection. Finally, once the remote VoIP client 12 is authenticated and provided a secure connection, the processor 42 will execute the routing logic 48 in order to properly route any phone calls to and from the remote VoIP client 12. Also, the routing logic 48 when executed by the processor 12, will correctly route telephone calls to and from the first and second VoIP telephones 26 and 27.

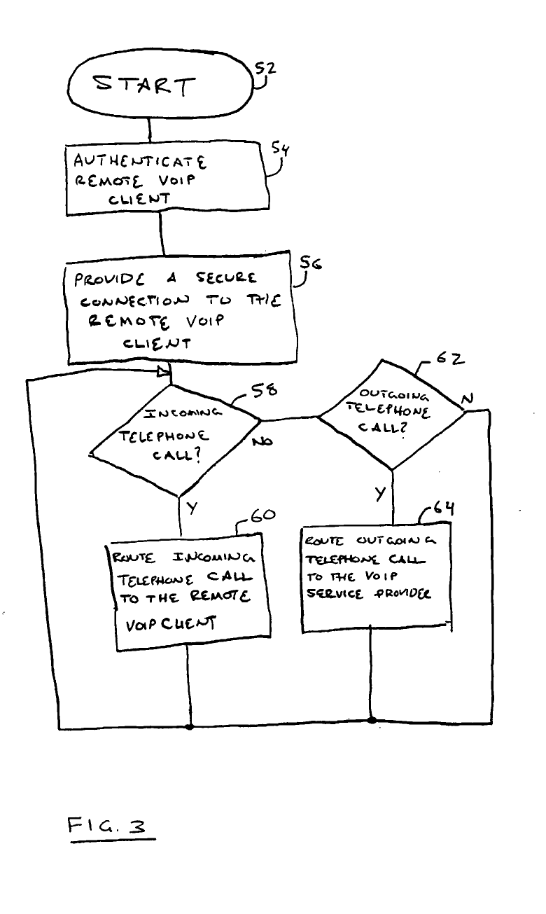

Referring to FIG. 3, a flow chart illustrating a method 50 for directing a VoIP telephone calls to and from a remote VoIP client is shown. Block 52 denotes the start of the method. In block 54, the remote VoIP client is authenticated. The remote VoIP device may be authenticated by using a table containing IP addresses of remote clients. If the VoIP remote client's IP address is in the table, the remote VoIP client will be authenticated.

Next, as shown in block 56, a secure connection is provided to the remote VoIP client. This is done by using a secure sockets layer correction.

As shown in block 58, once the remote VoIP client is authenticated and a secure connection provided, the method will then determine if there is an incoming telephone call to the remote VoIP client. If there is an incoming telephone call, as shown in block 60, the incoming telephone call is directed to the remote VoIP client.

Conversely, as shown in block 62, if it is determined that the remote VoIP client is making an outgoing telephone call, the telephone call will be routed to the VoIP service provider as shown in block 64. After block 60 and/or 64 has been executed, the method will return to block 58.

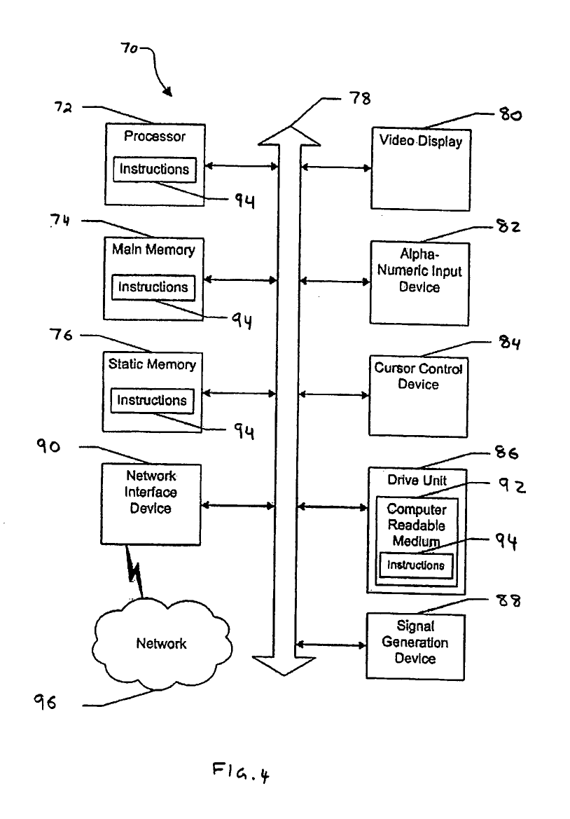

The IPT proxy device 34 may be a general computer system as shown in FIG. 4 and designated 70. The computer system 70 can include a set of instructions that can be executed to cause the computer system 70 to perform any one or more of the methods or computer based functions disclosed herein. The computer system 70 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 70 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 70 can be implemented using electronic devices that provide voice, video or data communication. Further, while a single computer system 70 is illustrated, the term “system” shall also be taken to include any collection of systems or sub-systems that individually or jointly execute a set, or multiple sets, of instructions to perform one or more computer functions.

As illustrated in FIG. 4, the computer system 70 may include a processor 72, e.g., a central processing unit (CPU), a graphics processing unit (GPU), or both. Moreover, the computer system 70 can include a main memory 74 and a static memory 76 that can communicate with each other via a bus 78. As shown, the computer system 70 may further include a video display unit 80, such as a liquid crystal display (LCD), an organic light emitting diode (OLED), a flat panel display, a solid state display, or a cathode ray tube (CRT). Additionally, the computer system 70 may include an input device 82, such as a keyboard, and a cursor control device 84, such as a mouse. The computer system 70 can also include a disk drive unit 86, a signal generation device 88, such as a speaker or remote control, and a network interface device 90.

In a particular embodiment, as depicted in FIG. 4, the disk drive unit 86 may include a computer-readable medium 92 in which one or more sets of instructions 94, e.g. software, can be embedded. Further, the instructions 94 may embody one or more of the methods or logic as described herein. In a particular embodiment, the instructions 94 may reside completely, or at least partially, within the main memory 74, the static memory 76, and/or within the processor 72 during execution by the computer system 70. The main memory 74 and the processor 72 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 94 or receives and executes instructions 94 responsive to a propagated signal, so that a device in communication with a network 96 can communicate voice, video or data over the network 96. Further, the instructions 94 may be transmitted or received over the network 96 via the network interface device 90.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A computer readable medium containing processor executable code for executing the following method:
authenticating a remote Voice over Internet Protocol (“VoIP”) client;
providing a secure connection to the remote VoIP client; and
routing incoming telephone calls to the remote VoIP client and outgoing telephone calls from the remote VoIP client without maintaining a virtual private network tunnel traversing a local are network (“LAN”) by directly routing incoming and outgoing VoIP telephone calls to the remote VoIP client.

2. The system of claim 1, wherein the secure connection is a secure sockets layer connection.

3. The system of claim 1, wherein the remote VoIP client includes software operating on a general purpose computer.

4. The system of claim 1, wherein the remote VoIP client is a dedicated device.

5. A system for redirecting VoIP telephone calls comprising:
an IPT proxy device in communication with an electronic communication network;
a remote VoIP client in communication with the electronics communication network and configured to communicate to the IPT proxy device; and
wherein the IPT proxy device configured to authenticate the remote VoIP client, provide a secure connection to the remote VoIP client and provide connectivity for the remote VoIP client to a VoIP service provider without maintaining a Virtual Private Network tunnel traversing a LAN by directly routing incoming and outgoing telephone calls to the remote VoIP client.

6. The system of claim 5, wherein the remote VoIP client comprises software operating on a general purpose computer.

7. The system of claim 5, wherein the remote VoIP client comprises a dedicated device.

8. The system of claim 5, wherein the secure connection comprises a secure sockets layer connection.

9. The system of claim 5, further comprising a router connected between the electronic communication network and the IPT proxy device, whereby the router connects the IPT proxy device to the electronic communication network.

10. The system of claim 5, further comprising:
a LAN in communication with the IPT proxy device;
a local VoIP client in communication with the LAN; and
wherein the IPT proxy device is configured to authenticate the local VoIP client and provide connectivity for the local VoIP client to the VoIP service provider.

11. The system of claim 10, wherein the local VoIP client comprises software operating on a general purpose computer.

12. The system of claim 10, wherein the local VoIP client is a dedicated device.

13. A system for redirecting VoIP telephone calls comprising:
an IPT proxy device in communication with an electronic communications network;
a remote VoIP client in communication with the electronic communications network and configured to communicate to the IPT proxy device;
a LAN in communication with the IPT proxy device and a local VoIP client;
the IPT proxy device configured to authenticate the local VoIP client and provide conductivity for the local VoIP client to a VoIP service provider; and
the IPT proxy device configured to authenticate the remote VoIP client, provide a secure sockets layer connection to the remote VoIP client and provide connectivity for the remote VoIP client to the VoIP service provider without maintaining a Virtual Private Network tunnel traversing LAN by directly routing outgoing and incoming telephone calls to the remote VoIP client.

14. The system of claim 13, wherein the remote VoIP client comprises software operating on a general purpose computer.

15. The system of claim 13, wherein the remote VoIP client is a dedicated device.

16. The system of claim 13, wherein a router is connected between the electronic communication network and the IPT proxy server, and wherein the router establishes a communication channel between the IPT proxy server and the Internet.

17. The system of claim 13, wherein the local VoIP client comprises software operating on a general purpose computer.

18. The system of claim 13, wherein the local VoIP client comprises a dedicated device.
